(19) United States
(12) Patent Application Publication
(10) Pub. No.: US 2024/0359393 A1
(43) Pub. Date: Oct. 31, 2024

(54) EMBOSS PATTERNS FOR THERMOPLASTIC FILMS

(71) Applicant: Poly-America, L.P., Grand Prairie, TX (US)

(72) Inventors: Brad A. Cobler, Irving, TX (US); Michael A. Ross, Inver Grove Heights, MN (US)

(21) Appl. No.: 18/507,926

(22) Filed: Nov. 13, 2023

Related U.S. Application Data
(60) Provisional application No. 63/498,687, filed on Apr. 27, 2023.

(51) Int. Cl. B29C 59/02; B65F 1/00

(52) U.S. Cl. CPC B29C 59/022; B65F 1/0006; B65F 2250/114

(57) ABSTRACT

The present invention relates to thermoplastic film having improved tear resistance, puncture resistance, and enhanced control of the film's elongation when subject to an applied load. The film can have an emboss pattern comprising a plurality of embossed regions, each embossed region comprising a plurality of closely spaced, non-intersecting sinusoidal shaped embosses. A sinusoidal emboss of an embossed region can be divided into three sections, wherein for each section along the emboss, the cross and machine orientation of the film can vary due to formation of the emboss. The emboss pattern can be arranged into various sections, wherein the amplitudes of the sinusoidal embosses of an embossed region can vary from one section of the pattern to another. The overall geometric shape of the embossed regions can also vary from one emboss region to another.

### CROSS-REFERENCE TO RELATED APPLICATIONS

This application claims priority to U.S. Provisional Appl. No. 63/498,687, filed on Apr. 27, 2023. The contents of this provisional application are incorporated by reference into this disclosure in its entirety.

### BACKGROUND OF THE INVENTION

### 1. Field of the Invention

The present invention relates to improvements for thermoplastic films, particularly thermoplastic films used in the manufacture of bags including trash bags. In particular, the present invention relates to improvements to trash bags and embossed patterns for such bags.

### 2. Description of the Related Art

Thermoplastic films are used in a variety of applications. For example, thermoplastic films are used in sheet form for applications such as drop cloths, vapor barriers, and protective covers. Thermoplastic films can also be converted into plastic bags, which may be used in a myriad of applications. The present invention is particularly useful to trash bags constructed from thermoplastic film, but the concept and ideas described herein may be applied to other types of thermoplastic films and bags as well.

Depending on the application, the use of thermoplastic film presents technical challenges due to the fact that thermoplastic film is inherently soft and flexible. Specifically, all thermoplastic films are susceptible to puncture and tear propagation. In some instances, it may be possible to increase the thickness of the film or select better polymers to enhance the physical properties of the film. However, these measures increase both the weight and cost of the thermoplastic film and may not be practicable. In light of the technical challenges of thermoplastic film, techniques and solutions have been developed to address the need for improved shock absorption to reduce the likelihood of puncture. For example, it is known to impart stretched areas into thermoplastic films as a means of inducing shock absorption properties into the film.

U.S. Pat. No. 5,205,650, issued to Rasmussen and entitled Tubular Bag with Shock Absorber Band Tube for Making Such Bag, and Method for its Production, discloses using thermoplastic film material with stretchable zones wherein the film material has been stretched in a particular direction with adjacent un-stretched zones that extend in substantially the same direction. The combination of the stretched zones and adjacent un-stretched zones provides a shock absorber band intended to absorb energy when the bag is dropped. Specifically, when a bag is dropped or moved, the contents inside the bag exert additional forces that would otherwise puncture or penetrate the thermoplastic film. However, the shock absorber bands absorb some of the energy and may prevent puncture of the film.

Another example of a thermoplastic film designed to resist puncture is disclosed in U.S. Pat. No. 5,518,801, issued to Chappell and entitled Web Materials Exhibiting Elastic-Like Behavior. Chappell, in the aforementioned patent and other related patents, discloses using a plurality of ribs to provide stretchable areas in the film much like Rasmussen. Chappell also discloses methods of manufacturing such thermoplastic film with such ribs.

Another example of shock absorption to prevent puncture is disclosed in U.S. Pat. No. 5,650,214 issued to Anderson and entitled Web Materials Exhibiting Elastic-Like Behavior and Soft Cloth-Like Texture. Anderson discloses using a plurality of embossed ribs defining parallel diamond-shaped areas with a network of unembossed material between the diamond-shaped areas. Thus, the unembossed area comprises a network of straight, linear unembossed material extending in two perpendicular directions. Anderson further discloses that such emboss patterns provide film with an elastic like behavior that is much more easily elongated than the same film without such emboss patterns applied. Polymeric films featuring such emboss patterns that provide for such ease of elongation or elastic-like behavior may be referred to as flexible film.

The foregoing specifically addresses the desire to increase the shock absorption of the thermoplastic film to reduce the likelihood of punctures occurring in the film. However, none of the foregoing solutions address the problem of reducing tear propagation in a thermoplastic bag.

Previously known solutions to limiting tear propagation are based on two primary concepts. First, longer and more tortuous tear paths consume more energy as the tear propagates and can help in limiting the impact of the tear in a bag or thermoplastic film. Second, many thermoplastic films, particularly thermoplastic films made using a blown-film extrusion process, have different physical properties along different axes of the film. Consequently, certain prior art solutions take advantage of the differential properties of thermoplastic films by redirecting tears into a different direction which offers greater resistance to the propagating tear. For example, some solutions redirect a tear propagating in the weaker machine direction of blown film into the stronger cross-direction.

One solution for reducing tear propagation is based on the idea that longer, tortuous tear paths are preferable and is described in U.S. Pat. No. 6,824,856, issued to Jones and entitled Protective Packaging Sheet. Jones discloses materials suitable for packaging heavy loads by providing an embossed packaging sheet with improved mechanical properties. Specifically, a protective packaging sheet is disclosed where surfaces of the sheet material are provided with protuberances disposed therein with gaps between protuberances. The protuberances are arranged such that straight lines necessarily intersect one or more of the protuberances. The resulting protective packaging sheet provides mechanical properties where tears propagating across the thermoplastic sheet are subject to a tortuous path. The tortuous path is longer, and more complex, than a straight-line tear, and a tear propagating along such a path would require markedly more energy for continued propagation across the film compared to a tear along a similar non-tortuous path in the same direction. Thus, due to the increased energy required for tear propagation, the tortuous path ultimately reduces the impact of any tears that do propagate across the film.

Another example of a tear resistant plastic film is disclosed in U.S. Pat. No. 8,357,440, issued to Hall and entitled Apparatus and Method for Enhanced Tear Resistance Plastic Sheets. Hall discloses an alternative tortuous path solution and further relies on the fact that certain polymer films, particularly thermoplastic films made in a blown-film extrusion process, are known to have a stronger resistance to tear in the cross direction (also known as the transverse direction) when compared to the machine direction (i.e. the direction in which the film is extruded). The cross direction (or transverse direction) is perpendicular to the machine direction and extends around the circumference of a blown-film tube or across the width of a flattened film.

Hall discloses a solution that contemplates using preferably shaped embosses, particularly convex shaped embosses with a curved outer boundary, to provide maximum resistance to tear propagation. In most thermoplastic films, a tear will have a tendency to propagate along the path of least resistance or in the machine direction. Hall contemplates redirecting propagating tears in a tortuous path with the additional intent of redirecting the machine direction tears along the curved edges of the embossed regions and into a cross direction orientation. The redirected tears in the cross direction will be subject to additional resistance and, preferably, will propagate to a lesser degree than a tear propagating in the machine direction in an unembossed film.

U.S. Pat. No. 9,290,303 to Brad A. Cobler with a filing date of Oct. 24, 2013, herein incorporated by reference into this disclosure, discloses use of an embossing pattern on polymeric film that balances both properties of shock absorption and tortuous tear paths in the cross direction, into a single, practicable polymeric film. The patent discloses that the embossing pattern comprises a plurality of embossed regions comprised of a plurality of parallel, linear embosses. The plurality of embossed regions is arranged so that a straight line cannot traverse the polymeric film without intersection at least one of the plurality of embossed regions. The disclosed embossing patterns further provides for enhanced stretching of the polymeric film, that is a flexible or flexed film, so that bags formed from the film can provide increased capacity in comparison to polymeric film without the disclosed embossing patterns.

The above discussed prior art addresses improving the shock absorption, reducing the risk of tear proportion, and enhancing the elongation properties of polymeric film. However, it would be desirable to provide improved tailoring of these traits for polymeric film for use in the manufacture of polymeric trash bags and other uses. In particular, it would be desirable to tailor these various behaviors to different sections of film and to vary the degree of the various behaviors. The present invention addresses these needs.

### SUMMARY OF THE INVENTION

The present invention in at least one embodiment comprises a thermoplastic film having machine and cross directions. The thermoplastic film can comprise a plurality of embossed regions embossed into the thermoplastic film and the plurality of embossed regions can be separated by a continuous, unembossed arrangement. Each of the plurality of embossed regions can comprise a set of sinusoidal embosses, wherein adjacent embosses of the set of sinusoidal embosses can be shaped and spaced from each other to avoid intersection with each other. The plurality of embossed regions can comprise a first embossed region and the first embossed region can comprise a first set of sinusoidal embosses. A sinusoidal emboss of the first set of sinusoidal embosses can include opposing first and second end sections and a central section. The first, second and central sections of the first sinusoidal emboss can extend along a length of the sinusoidal emboss. Further, the machine and cross directions of each of the first, second, and central sections of the first sinusoidal emboss can differ from each other.

In certain embodiments, the thermoplastic film can further comprise the adjacent embosses evenly spaced from each other. In various other embodiments, the adjacent embosses can vary in distance from each other. Each embossed region can be defined by a boundary with the continuous, unembossed arrangement. The boundary can further be defined by endpoints of the set of sinusoidal embosses and top and bottom sinusoidal embosses of the embossed region. The plurality of embossed regions can comprise a lower embossed region and an upper embossed region and the upper embossed region can be above the lower embossed region. Each emboss of the set of sinusoidal embosses of the lower embossed region can have a lower region amplitude and each emboss of the set of sinusoidal embosses of the upper embossed region can have an upper region amplitude. The lower embossed region amplitude can be different from the upper embossed region amplitude. Additionally, the lower embossed region amplitude can greater than the upper embossed region amplitude. In further embodiments, the lower embossed region amplitude can be less than the upper embossed region amplitude.

In other certain embodiments, the thermoplastic film can be incorporated into a drawstring trash bag. The set of sinusoidal embosses can comprise an upper emboss, a middle emboss, and a lower emboss. The upper emboss can be above the lower emboss and the middle emboss can be between the upper and lower embosses. The upper emboss can have an upper emboss amplitude, the middle emboss can have a middle emboss amplitude, and the lower emboss can have a lower emboss amplitude. The upper emboss amplitude, the middle emboss amplitude, and the lower emboss amplitude can each be different from each other. The upper emboss amplitude can be greater than the lower emboss amplitude, and the middle emboss amplitude can be in between the upper emboss amplitude and the lower emboss amplitude.

In further embodiments of the invention, an emboss pattern can be embossed onto a web of thermoplastic film. The thermoplastic film can have machine and cross directions. The emboss pattern can comprise an upper embossed section and the upper embossed section can have top and bottom emboss boundaries. The top and bottom emboss boundaries can extend generally in the machine direction and the upper embossed section can extend in the cross direction between the top and bottom emboss boundaries. A lower embossed section can be below the upper embossed section and the lower embossed section can have top and bottom emboss boundaries extending generally in the machine direction. The lower embossed section can extend in the cross direction between the top and bottom emboss boundaries and at least one of the top and bottom emboss boundaries of the upper and lower embossed sections can follow a sinusoidal path. The upper and lower embossed sections can comprise a plurality of embossed regions of embosses and each embossed region can be separated from adjacent embossed regions by an unembossed arrangement. An upper unembossed section can be above the top boundary of the upper embossed section and a middle unembossed section can extend from the bottom boundary of the upper embossed section to the top boundary of the lower embossed section. Furthermore, a lower unembossed section can be below the bottom emboss boundary of the lower embossed section and the upper, middle, and lower unembossed sections can have generally flat surfaces devoid of embosses.

In certain embodiments of the invention, each embossed region of the plurality of embossed regions can comprise a set of sinusoidal embosses. Additionally, each sinusoidal emboss of the set of sinusoidal embosses can be spaced from each other such that they do not intersect each other and each embossed region can be defined by a boundary with the continuous, unembossed arrangement. The boundary can be defined by endpoints of the sinusoidal embosses of the set of sinusoidal embosses and by top and bottom sinusoid embosses of the embossed region. The thermoplastic film of each sinusoidal emboss can be stretched in both the machine and cross directions by formation of the sinusoidal emboss. A magnitude of stretching for both the machine and cross directions can continuously vary along a length of each sinusoidal emboss.

In further embodiments of the invention, a sinusoidal emboss of the set of sinusoidal embosses can include opposing first and second end sections and a central section and the first, second, and central sections of the sinusoidal emboss can extend along a length of the sinusoidal emboss. The machine and cross direction orientations of each of the first, second, and central sections of the sinusoidal emboss can differ from each other. The top and bottom boundaries of the upper and lower embossed sections can follow one or more sinusoidal paths. The top and bottom boundaries of the upper section can follow an upper sinusoidal path and the top and bottom boundaries of the lower section can follow a lower sinusoidal path. The upper sinusoidal path can be different from the lower sinusoidal path and the upper sinusoidal path can have a different wavelength and amplitude from the lower sinusoidal path. In other embodiments, the one or more sinusoidal paths can have the same amplitude and wavelength. Furthermore, the thermoplastic film can be incorporated into a drawstring trash bag.

In other embodiments of the present invention, an emboss pattern can be embossed onto a web of thermoplastic film and the thermoplastic film can have machine and cross directions. The emboss pattern can comprise a first embossed section and the first embossed section can have top and bottom emboss boundaries. The top and bottom emboss boundaries can extend generally in the machine direction and the first embossed section can extend in the cross direction between the top and bottom emboss boundaries. A second embossed section can be separate from the first embossed section and the second embossed section can have top and bottom emboss boundaries extending generally in the machine direction. The second embossed section can extend in the cross direction between the top and bottom emboss boundaries. The first and second embossed sections can each comprise a plurality of embossed regions of embosses and each embossed region can be separated from adjacent embossed regions by an unembossed arrangement. Each embossed region of the first embossed section can comprise a set of sinusoidal embosses and a wavelength of the sinusoidal embosses can extend generally in the machine direction. Each of the embossed regions of the second embossed section can comprise a set of embosses extending generally in the machine direction. Each of the plurality of embossed regions of the first embossed section can have one or more first embossed region shapes and each of the plurality of embossed regions of the second embossed section can have one or more second embossed region shapes. The one or more first embossed region shapes can be different from the one or more second embossed region shapes.

In certain embodiments of the present invention, the one or more first and second embossed region shapes can include hexagonal, circular, or diamond shaped regions. Each emboss of the set of sinusoidal embosses of one of the plurality of embossed regions of the first embossed section can have a first amplitude. One of the plurality of embossed regions of the second embossed section can comprise a set of sinusoidal embosses. Each emboss of the set of sinusoidal embosses can have a second amplitude and the first amplitude can be different from the second amplitude. A third embossed section can be separate from the first and second embossed sections. The third embossed section can have top and bottom emboss boundaries extending generally in the machine direction. The third embossed section can further extend in the cross direction between the top and bottom emboss boundaries. The third embossed section can comprise a plurality of embossed regions of embosses and each embossed region can be separated from adjacent embossed regions by an unembossed arrangement. Each embossed region of the third embossed section can comprise a set of sinusoidal embosses and a wavelength of the sinusoidal embosses can extend generally in the machine direction. Each emboss of one set of sinusoidal embosses of the plurality of embossed regions of the third embossed section can have a third amplitude. In various embodiments, the first, second and third amplitudes can be different from each other and the first amplitude can be less than the second amplitude and the second amplitude can be less than the third amplitude.

In a further embodiment of the present invention, an emboss pattern can be embossed onto a web of thermoplastic film and the thermoplastic film can have machine and cross directions. The emboss pattern can comprise a plurality of embossed regions embossed into the thermoplastic film and the plurality of embossed regions can be separated by a continuous, unembossed arrangement. The plurality of embossed regions can comprise at least an upper embossed region and a lower embossed region. Each of the plurality of embossed regions can comprise a set of sinusoidal embosses, wherein adjacent embosses of the set of sinusoidal embosses are shaped and spaced from each other to avoid intersection with each other. The set of sinusoidal embosses of the upper embossed region can comprise at least first and second sinusoidal embosses. The first sinusoidal emboss can comprise a first amplitude and the second sinusoidal emboss can comprise a second amplitude. The set of sinusoidal embosses of the lower embossed region can comprise at least third and fourth sinusoidal embosses. The third sinusoidal emboss can comprise a third amplitude and the fourth sinusoidal emboss can comprise a fourth amplitude. The first amplitude can be different from the second amplitude.

In certain embodiments of the present invention, the third amplitude can be different from the second amplitude and the fourth amplitude different from third amplitude. Additionally, the first, second, third, and fourth amplitudes can each be different from each other. The first amplitude can be less than the second amplitude, the second amplitude can be less than the third amplitude, and the third amplitude can be less than the fourth amplitude. The upper embossed region can be above the lower embossed region and the first sinusoidal emboss of the upper embossed region can be above the second sinusoidal emboss of the upper embossed region. Lastly, the first sinusoidal emboss of the lower embossed region can be above the second sinusoidal emboss of the lower embossed region.

It is contemplated that the present invention may be utilized in ways that are not fully described or set forth herein. The present invention is intended to encompass these additional uses to the extent such uses are not contradicted by the appended claims. Therefore, the present invention should be given the broadest reasonable interpretation in view of the present disclosure, the accompanying figures, and the appended claims.

### BRIEF DESCRIPTION OF THE RELATED DRAWINGS

A full and complete understanding of the present invention may be obtained by reference to the description of the present invention and certain embodiments when viewed with reference to the accompanying drawings. The drawings can be briefly described as follows.

FIG. 1 provides a plan view of a prior art emboss pattern.

FIGS. 2A and 2B provide plan views of a first embodiment of the present invention. FIG. 2A shows the first embodiment under no strain and FIG. 2B shows the embodiment under strain in the cross direction.

FIG. 2C provides a view of the profile of a single emboss of an emboss pattern of the first embodiment of FIGS. 2A and 2B.

FIG. 3 provides a front view of a drawstring trash bag with the pattern of FIG. 2A applied to the body of the drawstring trash bag.

FIG. 4 provides a perspective view of the bag of FIG. 2A with the bag opened.

FIG. 5 provides a plan view of a second embodiment of the present invention.

FIG. 6 provides a front view of a drawstring trash bag with a third embodiment of the present invention on the body of the bag.

FIG. 7 provides a front view of a drawstring trash bag with a fourth embodiment of the present invention on the body of the bag.

FIG. 8A shows a limited range chart of test result data of force versus elongation (force-to-stretch) in the cross-direction (CD) for the first embodiment of the present invention applied to various samples of polymeric film.

FIG. 8B shows an extended range chart of the same test result data as FIG. 8A.

FIG. 8C shows a chart of test result data of force versus elongation in the machine direction (MD) for the same test samples as the charts of FIGS. 8A and 8B.

FIG. 9 provides a plan view of a fifth embodiment of the present invention.

FIG. 10 provides a plan view of a sixth embodiment of the present invention.

FIG. 11 provides a plan view of a seventh embodiment of the present invention.

### DESCRIPTION OF THE INVENTION

The present disclosure illustrates several embodiments of the present invention. It is not intended to provide an illustration or encompass all embodiments contemplated by the present invention. In view of the disclosure of the present invention contained herein, a person having ordinary skill in the art will recognize that innumerable modifications and insubstantial changes may be incorporated or otherwise included within the present invention without diverging from the spirit of the invention. Therefore, it is understood that the present invention is not limited to those embodiments disclosed herein. The appended claims are intended to more fully and accurately encompass the invention to the fullest extent possible, but it is fully appreciated that certain limitations on the use of particular terms are not intended to conclusively limit the scope of protection.

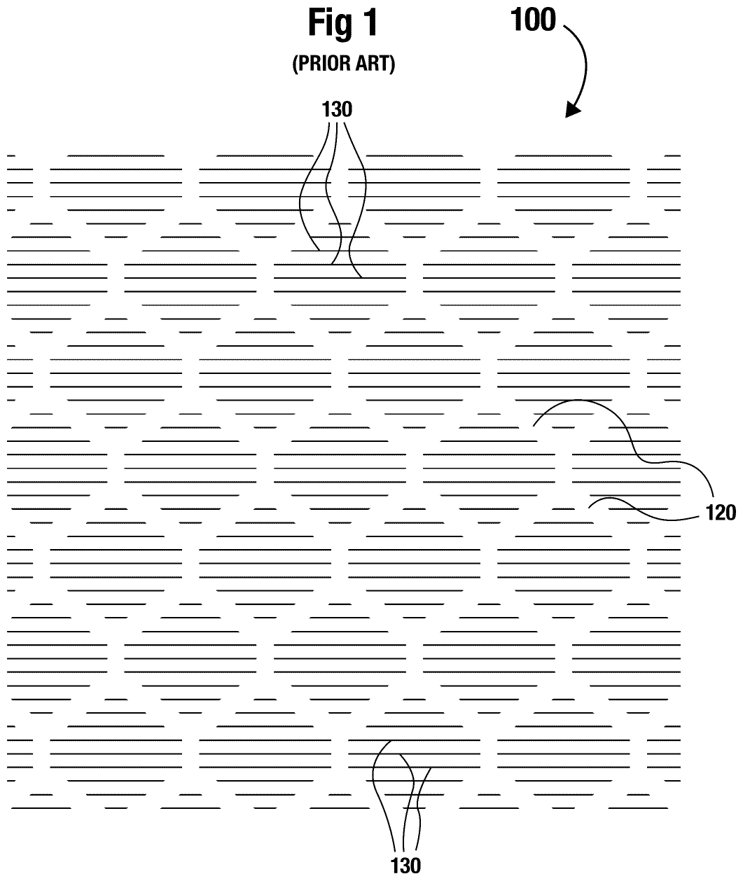

Referring initially to FIG. 1, a plan view of a prior art emboss pattern is shown. In particular, an emboss pattern 100 is applied to thermoplastic film. The emboss pattern 100 comprises a plurality of embossed regions 110, where each of the plurality of embossed regions 110 is separated by a continuous, unembossed arrangement 120. Each of the embossed regions 110 comprises a plurality of parallel linear embosses 130 that forms an embossed region 110 shaped as a hexagon. The parallel, linear embosses 130 are all arranged in a parallel fashion throughout the emboss pattern 100 to facilitate expansion of the film in the direction perpendicular to the direction that the linear embosses extend. Furthermore, the parallel, linear embosses 130 extend across each embossed region 110. Due to the arrangement of the hexagon-shaped embossed regions 110 such that a straight line cannot traverse the pattern without intersecting an embossed region, the emboss pattern 100 can prevent the propagation of tears in polymeric film comprising pattern 100. This prior art emboss pattern is more fully described in U.S. Pat. No. 9,546,277 to Cobler with a filing date of Mar. 23, 2015, which is herein incorporated by reference into this disclosure in its entirety.

Films with emboss patterns such as the emboss pattern 100 of FIG. 1 are commonly referred to as flexed film. The embossed regions form regions within the film that are pre-stretched while the film in the unembossed arrangement prevents the overall film web from stretching—the overall dimensions of the web do not change when the emboss pattern is applied. However, due to the pre-stretched embossed regions, the film easily expands when tension is applied to the film in a direction perpendicular to the extension of the linear embosses; that is the embossed regions generally experience geometric deformation while the unembossed arrangement experiences primarily molecular deformation and collapses or straightens in the direction of the applied load. Such ease of elongation behavior can also be referred to as elastic-like. If such a film is used to fashion a bag, such as a drawstring trash bag, this behavior can allow the capacity of the bag to increase when it is loaded with contents, especially if the flexing is aligned in the vertical direction of the bag with the bag's opening at the top of the bag. In contrast to this behavior, when tension is applied to the web in a direction parallel to the extension of the linear embosses, typically in the horizontal direction, the film fails to expand or elongate and rather behaves similarly to film with the same composition but with no such emboss pattern.

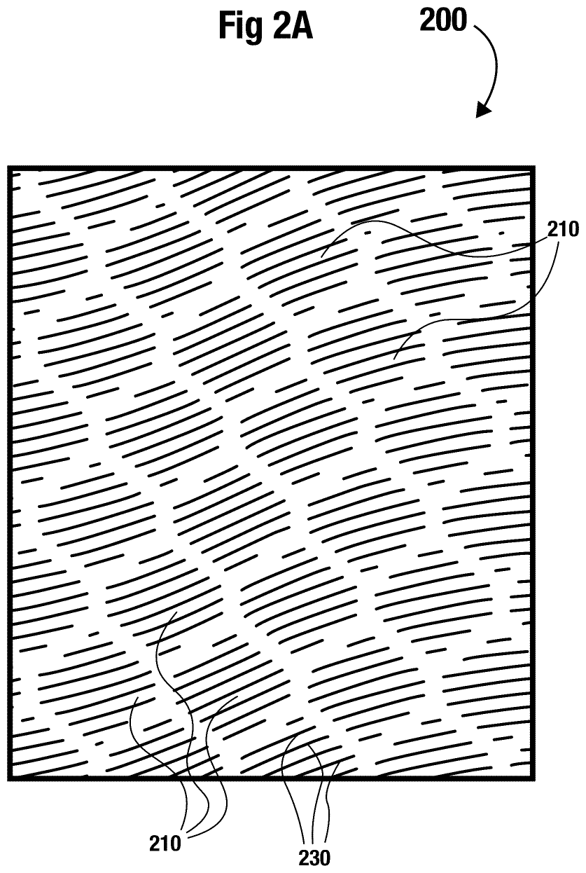

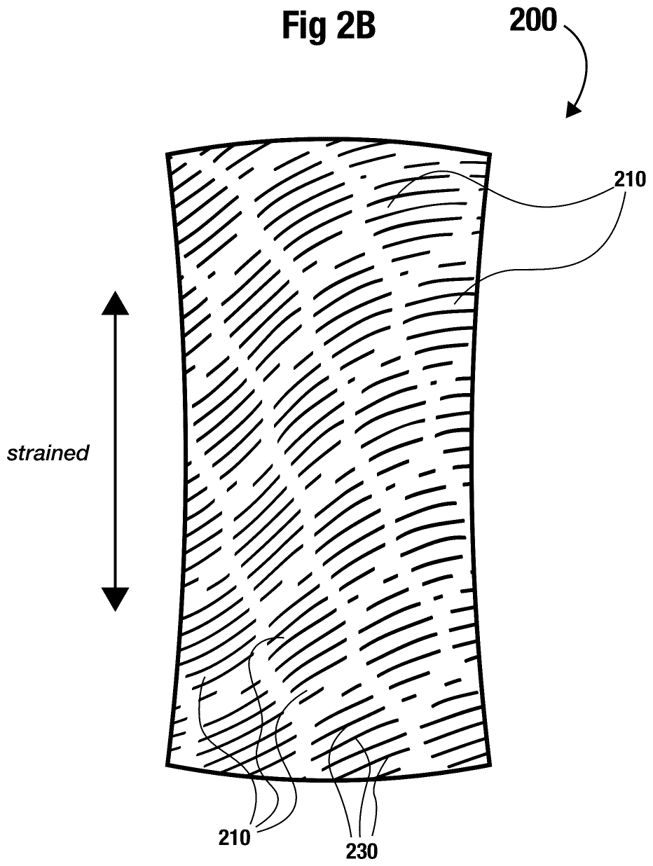

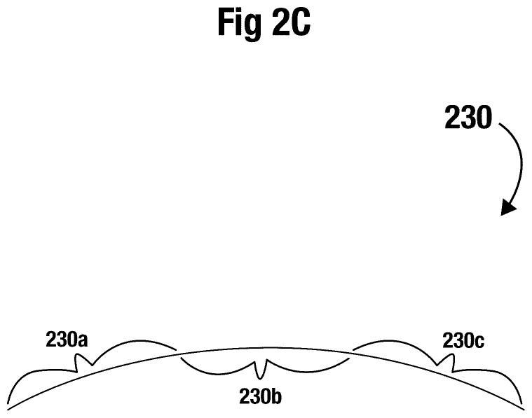

Now turning to FIGS. 2A and 2B, a first embodiment of the present invention is illustrated. FIG. 2A illustrates the embodiment in an unstrained configuration while FIG. 2B illustrates the change in the film's geometry due to the emboss pattern 200 under an applied strain in the cross direction. In this embodiment, the emboss pattern 200 has a plurality of embossed regions 210 that are generally hexagonal in shape. Unlike the prior art, the individual embosses of the set of adjacent embosses 230 of each embossed region 210 are not linear. Rather than linear, each emboss 230 is curvilinear; in particular, each emboss 230 follows a sinusoidal path.

Within this disclosure, use of the term “sinusoidal” describes the shape of an element that follows a fractional length of a sinewave. As shown in FIG. 2A, for this embodiment of the invention, the amplitude and wavelength of all of the sinusoidal embosses 230 are constant; however, in various embodiments, the amplitude and/or the wavelength of the sinusoidal embosses can vary from one embossed region to another or even within a single embossed region 210. Nonetheless, the waveforms of the sinusoidal embosses 230 are formed such that they do not intersect each other and at least a minimal gap is maintained between adjacent sinusoidal embosses.

Additionally, throughout this disclosure, emboss patterns are illustrated without any significant width or depth for the ease of illustration. A person having ordinary skill in the art will understand that there is a certain amount of width and depth to each emboss (or embossment). In fact, the depth-of-engagement of the embossing process is addressed below, indicating that each embossment or emboss is given a certain amount of depth into the film due to the process of embossing.

For the FIG. 2A embodiment, because all of the sinusoidal embosses have the same amplitude and wavelength, the spacing between adjacent embosses 230 is even. However, for various other embodiments where the amplitude and/or wavelength varies between adjacent sinusoidal embosses, the spacing can vary due to the variation in the shape of the sinewaves that the embosses follow.

As well known in the art, polyethylene film can easily be oriented by stretching the film—that is the orientation of the molecular chains of the polymer. Film properties, such as tear strength and dart impact (ASTM testing standards D-1922 and D-1709, respectively), can be materially changed in both the direction of stretch and perpendicular to the direction of stretch. Typically, this orientation is accomplished by stretching the film in the machine direction (MD), the cross direction (CD), or both. For extruded polymeric film, the MD refers to the direction that the film was extruded in and the CD refers to the direction perpendicular to the MD. Especially for polymeric film formed via blown film extrusion, the tear strength of the film is known to be intrinsically lower in the MD in comparison to the film's tear strength in the CD.

In the present invention where sinusoidal stretching is utilized in a flex emboss pattern, such as that of emboss pattern 200, the polymeric film is stretched in continuously variable directions. For such stretching, the direction of stretch is in general perpendicular to a tangent line on a given point of the waveform for a sinusoidal emboss. The degree of variation of stretch direction can be changed by varying the amplitude and wavelength of the sinewave. Additionally, the amount that the film is stretched can be controlled by the depth of engagement of mating rollers, that is how deep a pair of circumferentially grooved rollers (following a sinusoidal path about the circumference of the rollers) used to form the embosses are engaged with each other. If a film is passed through a pair of mating rollers that have continuous sinusoidal stretch bands over the entire circumference of the rollers, the film will grow in all directions of stretch. However, if a pattern of geometric shapes is cut into one of the rollers such that only the film within the geometric shape is stretched, then the overall dimension of the film remains stable. This pattern of geometric shapes with stretched film in their interior allows the film to flex or stretch to a much greater degree than the film would stretch due to its own elasticity when force is applied to the film in the direction of stretch.

Now turning to FIG. 2C, a single sinusoidal embosses 230 is shown divided into three sections along its arcuate length, as indicated by the three brackets. Emboss 230 is shown divided into opposing first and second end sections 230a and 230c and a central section 230b. For at least certain embodiments, the three sections 230a, 230b, and 230c can have about equal lengths along the sinusoidal path. As explained above, due to the sinusoidal shape of emboss 230, the film orientation of each one of these sections is different. The amount and direction of orientation that the film experiences in the MD and CD is not the same in any one of the sections 230a, 230b, and 230c due to the sinusoidal shape of emboss 230.

Now returning to FIG. 2A, for the emboss pattern 200, an embossed region boundary can be defined for each embossed region 210. The boundary can comprise the uppermost and lowermost sinusoidal embosses 230 of a particular region 210 along with the endpoints of all of the sinusoidal embosses 230 of the same region 210.

As illustrated by FIG. 2B, because the flexing emboss pattern 200 is non-uniform, that is the sinusoidal embosses pre-stretch the film in both the cross and machine directions, when the film is strained in the cross direction, it stretches in a non-uniform manner. As illustrated, when strained, rather than linear stretch lines (undulations in the film due to the film collapsing, the peaks and valleys of the undulations transverse to the direction of strain), this non-uniform flexing forms sinusoidal-shaped stretch lines. Also, in contrast to the prior art emboss pattern of FIG. 1, the borders of the FIG. 2B embodiment take on a sinusoidal profile due to the sinusoidal shape of the embosses 230 comprising each of the emboss regions 210.

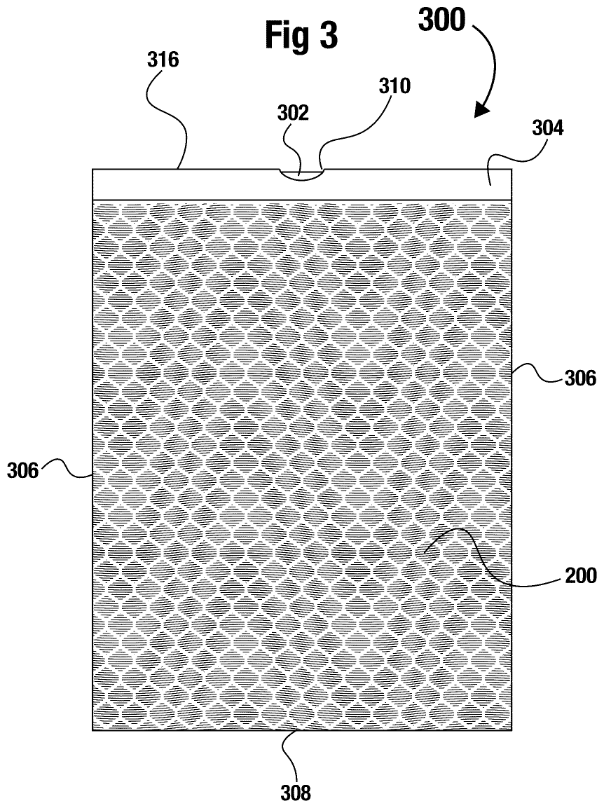

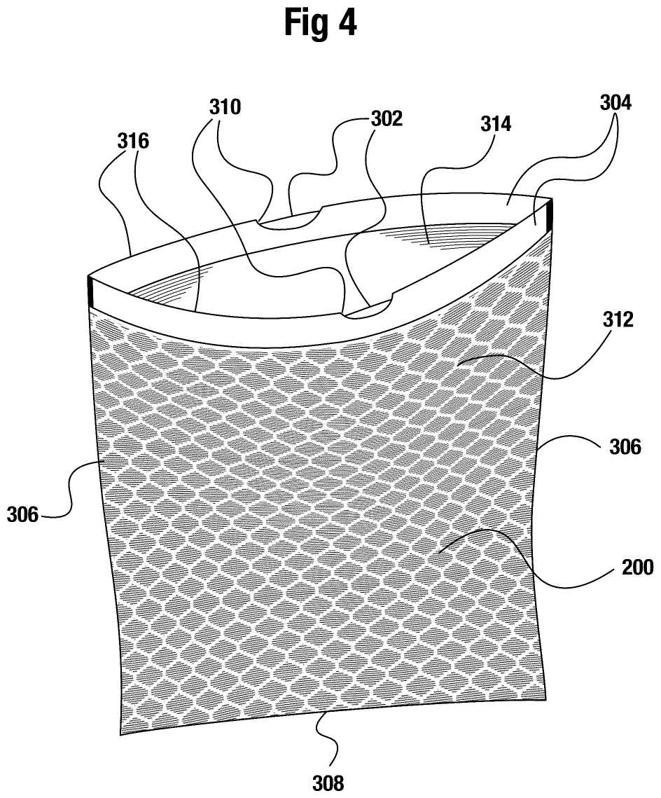

Now examining FIGS. 3 and 4, these two figures illustrate front and perspective views of a drawstring trash bag 300 with the emboss pattern 200 of FIG. 2 applied to the body of bag 300. As best illustrated by FIG. 4, bag 300 includes front and rear panels 312 and 314, first and second drawstrings 302, first and second hems 304, side edges 306, bottom edge 308, top edges 316, and drawstring cutouts 310. For ease of illustration, emboss pattern 200 is not shown on rear panel 314 of bag 300.

As shown in FIGS. 3 and 4, emboss pattern 200 is not shown to scale for the sake of clarity. For instance, in at least certain embodiments, a width of a drawstring trash bag can be approximately 24 inches and the width of an embossed region can be about 0.5 inches or less. Such dimensions provide for approximately 50 embossed regions along the width of a bag while only around 15 regions are shown along a width of bag 200 of FIG. 3. If the emboss pattern 200 were shown to scale, the detail of the sets of embosses 230 comprising the plurality of embossed regions 210 would be unclear.

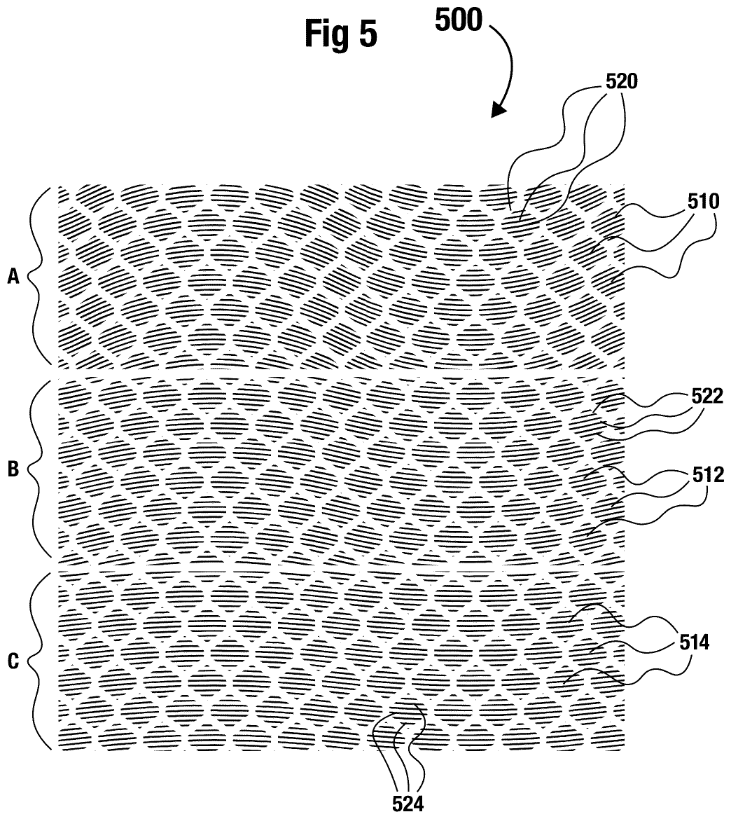

Looking now at FIG. 5, a second embodiment of the present invention is depicted wherein the amplitude of the sinusoidal embosses varies. The emboss pattern 500 is shown with three distinct zones: Zone A, Zone B, and Zone C as indicated by the brackets to the left of the drawing. Each zone is separated from adjacent zones by a break in the emboss pattern where the film that the emboss pattern is applied to has no embossing. Zone A contains a plurality of first embossed regions 510 with each first embossed region 510 comprising a set of adjacent sinusoidal embosses 520. The sinewave that embosses 520 follow has a first amplitude. Zone B located below Zone A contains a plurality of second embossed regions 512 with each of these regions 512 comprising a set of adjacent sinusoidal embosses 522 having a second amplitude. Zone C located below Zone B contains a plurality of third embossed regions 514 with each of these regions 514 comprising a set of adjacent sinusoidal embosses 524 having a third amplitude.

Within the FIG. 5 embodiment, the first, second, and third amplitudes vary from each other while the wavelength of the sinusoids are the same. In various other embodiments, both the wavelength and the amplitude of the sinewave shaped embosses can vary. As shown by FIG. 5, for pattern 500, the second amplitude is greater than the third amplitude and the first amplitude is greater than the second amplitude. In at least one particular embodiment, the width of embossed regions 510, 512, and 514 can be approximately 0.5 inch, a wavelength of the sinewaves followed by the sinusoidal embosses can be approximately 10 to 10.5 inches and the amplitude of the various sinewaves can vary from about 0.15 to about 0.60 inches. In at least one embodiment, the first amplitude can be 0.60 inch, the second amplitude can be 0.30 inches and the third amplitude can be 0.15 inches.

Embodiment 500 having three zones with the sinusoidal embosses varying in amplitude allows for tailoring of the physical properties of the film for particular advantages. If such a pattern is used on the film of a drawstring trash bag, how the film flexes for each zone is varied. For instance, if zone B's amplitude has an amplitude lower than the first and third amplitude, zone B's film will stretch a lesser amount than the film in Zone A and Zone C. Controlling the amount of flexing can impart an impression of strength to a consumer while still providing the advantages of flexing, such as increased capacity. Controlling the amount of flexing of the film can also control the bag's length if loaded excessively with heavier contents so that a user of the bag may still lift the bag without the bag experiencing excessive elongation. Excessive elongation as described can interfere with removal of the bag from inside a container or simply interfere with picking up the bag from the ground.

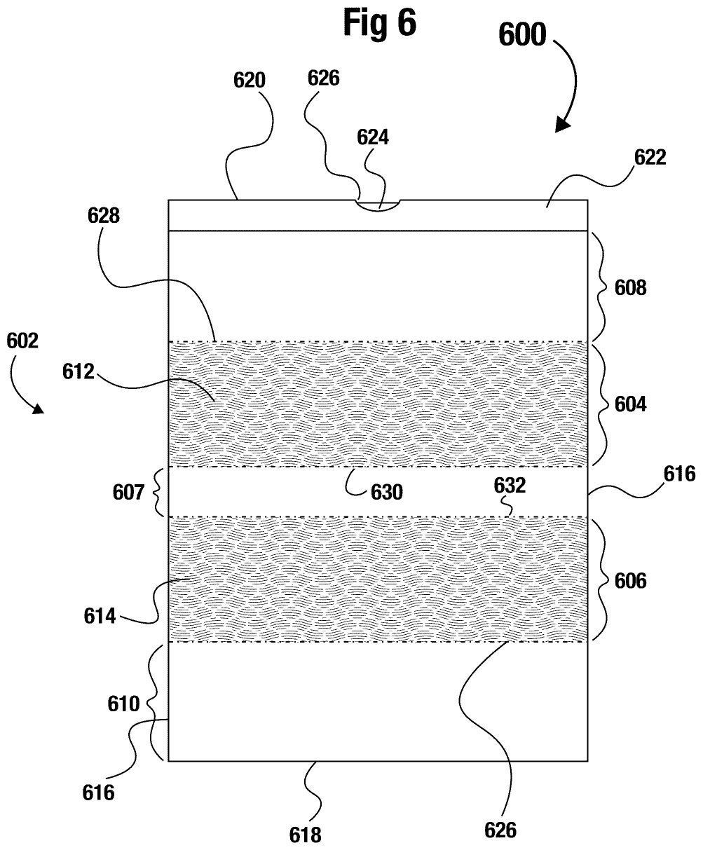

Now turning to FIG. 6, emboss pattern 602 is shown. FIG. 6 further shows emboss pattern 602 applied to the thermoplastic film of a drawstring trash bag 600. Emboss pattern 602 includes upper embossed section 604 and lower embossed section 606. In between the two embossed sections 604 and 606 is shown middle unembossed section 607. Located above upper embossed section 604 is shown upper unembossed section 608 and below lower embossed section 606 is shown lower unembossed section 610.

At the top of upper embossed section 604 is shown top emboss boundary 628 and at the bottom of upper embossed section 604 is shown bottom emboss boundary 630. Lower embossed section is bounded by top emboss boundary 632 at its top and by bottom emboss boundary 626 at its bottom. Each emboss boundary 628, 630, 632, and 626 of FIG. 6 are linear in emboss pattern 602. Emboss boundaries 628, 630, 632, and 626 are shown as dot-dash lines to indicate that the lines merely show the boundaries between the embossed and unembossed sections and that no structure is indicated.

The emboss pattern 602 of FIG. 6 provides additional advantages over the emboss pattern 200 of FIG. 2. As discussed above, flex patterns such as the prior art emboss patterns and the emboss patterns of this invention enable polymeric film to expand and to increase its holding capacity when utilized to form bags or for other purposes. Such patterns can also allow films to conform to blunt objects placed within bags utilizing the emboss patterns on polymeric films of this invention. However, because the embosses thin out the film in isolated locations, placing sharper objects within such bags can increase the risk of punctures. Thus, such patterns as emboss pattern 602 can be utilized to allow a bag to expand in certain desirable areas and also provide a lower risk of puncture in other areas.

Returning to FIG. 6, a front side of drawstring trash bag 600 further includes first and second side edges 616, bottom edge 618, top edge 620, hem 622, drawstring 624, and drawstring cutout 626. Embossed sections 604 and 606 and unembossed sections 607, 608, and 610 are bounded in the horizontal direction by opposing side edges 616. Rear side of bag 600 is identical to the front side of bag 600 and thus not shown.

In at least certain embodiments, bag 600 of FIG. 6 can have its bottom and top edges 618 and 620 coincide with the machine direction of the polymeric film that forms the bag. For such a bag, the emboss boundaries 628, 630, 632, and 626 also extend in the machine direction. The embossed sections 604 and 606 then extend between the opposing side edges 616 in the machine direction and between their boundaries in the cross direction of the polymeric film.

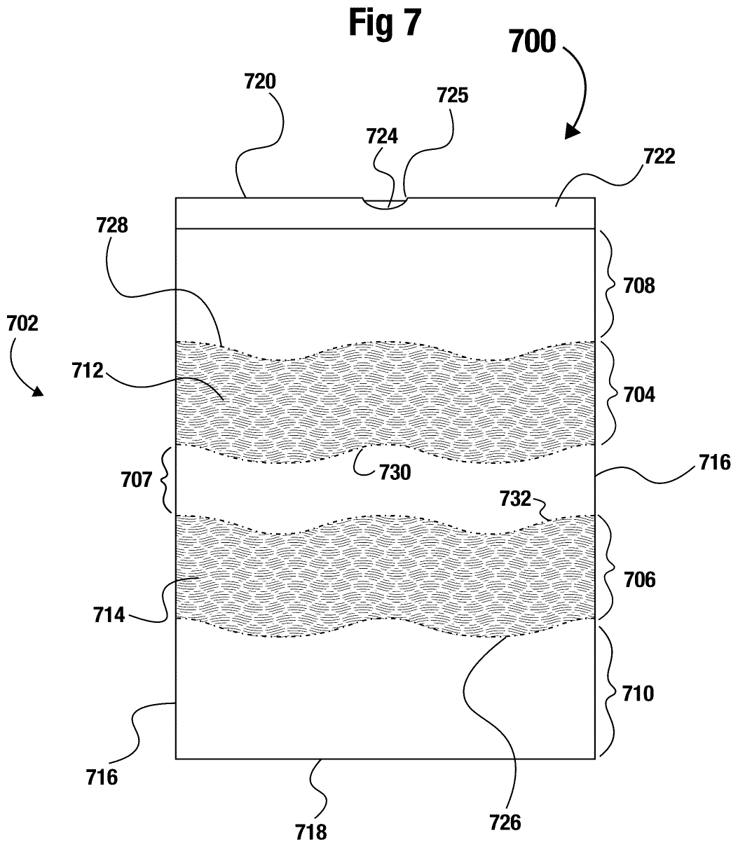

Now turning to FIG. 7, emboss pattern 702 is shown. Emboss pattern 702 is further shown as incorporated into drawstring trash bag 700. Emboss pattern 702 includes upper embossed section 704 and lower embossed section 706. In between the two embossed sections 702 and 704 is shown middle unembossed section 707. Located above upper embossed section 702 is shown upper unembossed section 708 and below lower embossed section 706 is shown lower unembossed section 710.

FIG. 7 further shows top emboss boundary 728 at the top of upper embossed section 704 and bottom emboss boundary 730 at the bottom of upper embossed section 704. Lower embossed section is bounded by top emboss boundary 732 at its top and by bottom emboss boundary 726 at its bottom. Emboss boundaries 728, 730, 732, and 726 are shown as dot-dash lines to indicate that the lines merely show the boundaries between the embossed and unembossed sections and that no structure of bag 700 or pattern 702 is indicated.

As further shown by FIG. 7, a front side of drawstring trash bag 700 includes first and second side edges 716, bottom edge 718, top edge 720, hem 722, drawstring cutout 725, and drawstring 724. Embossed sections 704 and 706 and unembossed sections 707, 708, and 710 are bounded in the horizontal direction by opposing side edges 716. Rear side of bag 700 is identical to the front side of bag 700 and thus not shown.

Unlike emboss pattern 602 of FIG. 6, the emboss boundaries of emboss pattern 702 of FIG. 7 are not linear but rather curvilinear. In particular, each of these emboss boundaries 726, 728, 726 and 730 follow a sinusoidal path. In at least certain embodiments, the wavelength of this sinusoidal path can be between 5 and 20 inches with amplitudes between 0.15 and 2 inches.

Emboss boundaries 726, 728, 726 and 730 following a sinusoidal path can be advantageous. For instance, tears are known to form and propagate in thin polymeric films, especially in the machine direction for films formed by blown film extrusion, which is commonly used to construct drawstring trash bags. In such bags, the machine direction typically extends in the horizontal direction. However, if such a tear begins to form at an emboss boundary, the sinusoidal path of the boundary can redirect the tear away from the machine direction and prevent the tear from propagating.

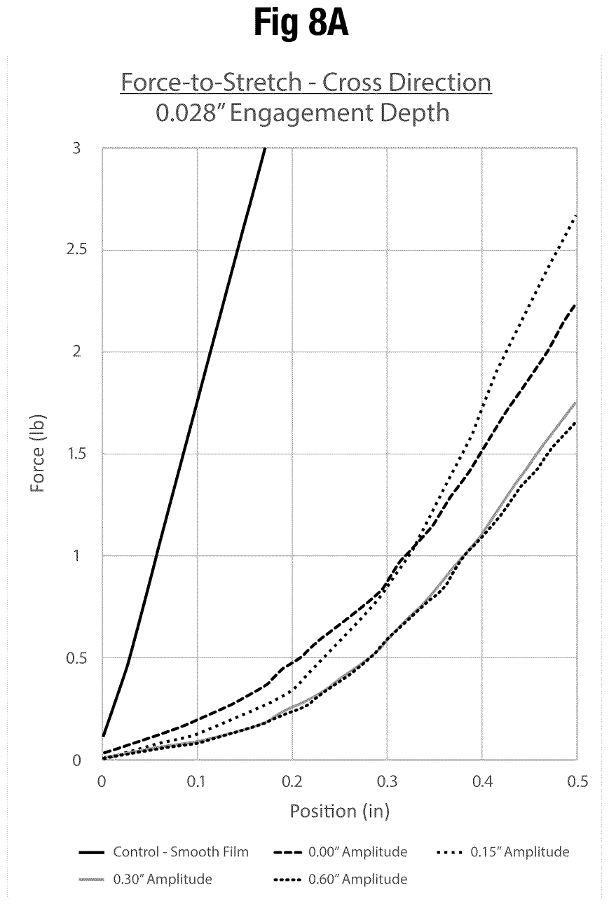

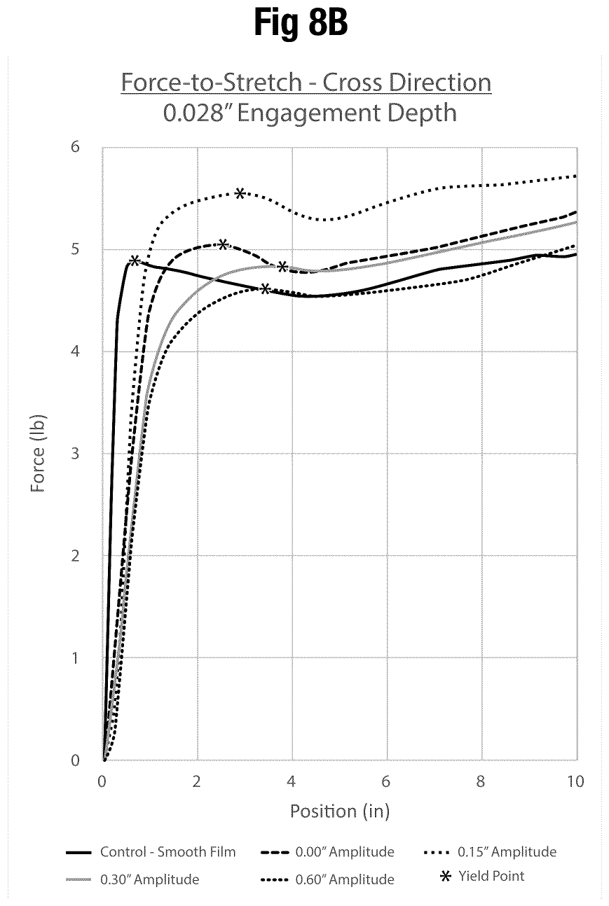

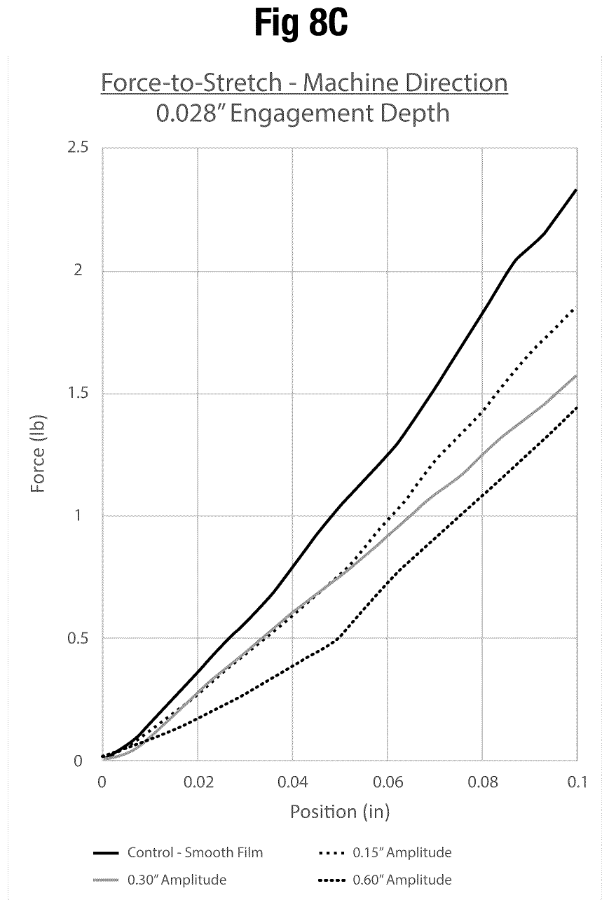

FIG. 8A shows a chart for the amount of force in pounds (lb) required to stretch various four-inch square samples of film in the cross direction (CD) for the initial 0.5 inches of elongation. The amount of stretching, or the elongation of the film (position) is measured in inches (in) on the chart. Such curves are commonly referred to as force-to-stretch curves by the Applicant. Each test sample comprises a linear low density polyethylene (LLDPE) film with a nominal gauge of 0.9 mil. The emboss pattern 200 of FIG. 2 was applied to the samples with the amplitude of the sinusoidal embosses as indicated by the chart at 0.15, 0.30, and 0.60 inches. The test results for the prior art emboss pattern 100 of FIG. 1 is also provided on the chart and indicated by the 0.00″ amplitude. Further included on the chart is the force-to-stretch “control” curve of a sample of comparable smooth film with no emboss pattern applied to the film. A depth of engagement of 0.028 inches was utilized on each sample having an emboss pattern.

FIG. 8A illustrates that varying the amplitude of the emboss pattern can provide a means of providing increased stretching for a given load, especially at relatively small elongations. For instance, for a 0.2-inch elongation (5% of the sample's length), the prior art emboss pattern (amplitude of 0.00″) has force-to-stretch of 0.5 pounds, while the 0.15-inch amplitude pattern has a force-to-stretch of 0.35 pounds. The higher amplitude patterns of 0.30 and 0.60 inches exhibit even less force-to-stretch at a 0.2-inch elongation.

This lower required force-to-stretch is understood to be due to the increased area of film that is stretched by the higher amplitude patterns. The higher amplitude patterns have an increased area of stretched film because the overall length of each of the embossments is greater in comparison to the prior art linear embossments (a curved line is longer overall than a straight line), even though the area of each embossed region is comparable to each other. Thus, at an elongation of 0.2 inches, the 0.30-inch amplitude pattern has a force-to-stretch of approximately 0.28 pounds and the 0.60-inch amplitude pattern has a force-to-stretch of approximately 0.24 pounds (less than half of the prior art pattern at this elongation). The higher amplitude patterns also show that the sinusoidal flexing emboss patterns can reach a maximum or plateau of enhanced stretching or flexing for a given film and depth of engagement. This behavior is demonstrated by the results for the 0.30-inch and 0.60-inch amplitude samples where the curves of these two test samples show very similar results, especially at lower elongations as shown in FIG. 8A with very little separation between the two curves.

The results of FIG. 8A also demonstrate that lower amplitude emboss patterns can begin to stretch at a lower force-to-stretch than the prior art pattern, but then require a greater force-to-stretch than the prior art pattern at increased elongations. This behavior is exhibited in the FIG. 8A chart where the 0.00″ and 0.15″ curves intersect each other. In particular, as discussed above, at 0.2 inches of elongation, the 0.15-inch pattern has a lower force-to-stretch than the prior art pattern. However, at an elongation of 0.4 inches (10% of the sample's length), the force-to-stretch for the prior art pattern is less than the 0.15-inch amplitude pattern (approximately 1.5 pounds versus 1.62 pounds).

At higher elongations, this behavior of the lower amplitude sinusoidal pattern building an increased load in comparison to the prior art pattern is even more pronounced. For instance, at an elongation of 0.5 inches, the force-to-stretch of the 0.15-inch pattern is approximately 2.7 pounds, while the force-to-stretch of the prior art pattern is approximately 2.25 pounds. It is expected, that at lower amplitudes, such as the 0.15-inch amplitude pattern (this behavior is not exhibited by the higher amplitude patterns, at least at this depth of engagement for this particular material), the increased area of stretched film is not adequate to offset the variation in the direction of stretch from the cross direction and towards the machine direction. Further, this stretching in both directions leads to incongruities or non-uniformities (as discussed in regards to FIG. 2B above) in the stretching of the film that interfere with the film's ability to expand at a given force.

FIG. 8B expands upon the same results as FIG. 8A with a more expansive data set but with less detail. The FIG. 8B chart further shows the approximate yield point for each test sample with an asterisk. As illustrated on the chart, the inventive patterns with certain amplitudes substantially increase the material's yield point in comparison to the prior art pattern. For instance, the 0.15-inch pattern's yield point is approximately 5.54 pounds versus the prior art pattern's yield point of approximately 5 pounds.

Not only do certain inventive patterns have increased yield points, but the FIG. 8B results also demonstrate that the yield curve is flattened considerable for all of the inventive patterns in comparison to the prior art pattern. For example, the 0.15-inch pattern begins carrying a 5.35-pound load (99% of its yield point) at an elongation of less than 1.45 inches and continues to carry the same load or more until it reaches an elongation of over 4 inches. This stands in contrast to the prior art emboss pattern where it reaches 99% of its yield point at approximately 1.65 inches and stops carrying this load at approximately 3.1 inches (a distance of approximately 2.55 inches versus a distance of approximately 1.45 inches). This behavior of the 0.15-inch pattern (and likely patterns with comparable amplitudes) can be particularly advantageous when applied to a drawstring trash bag. These properties allow for a bag to expand its volume to a much greater extent than a bag using the prior art pattern and it also provides the a considerably higher load carrying capacity.

The FIG. 8B chart further illustrates that the higher amplitude patterns of 0.30-inch and 0.60-inch have a lower yield point than the prior art pattern. However, the yield point of these two inventive patterns is at a much greater elongation than the prior art pattern and the lower amplitude 0.15-inch pattern. The yield point for the 0.60-inch pattern is approximately at 3.4 inches and the yield point for the 0.30-inch pattern is approximately at 3.8 inches. Therefore, although these higher amplitude patterns have lower yield points and hence less usable strength, they expand when strained to a much greater extent than the prior art and lower amplitude inventive patterns prior to yield. Depending upon the application, this behavior can provide advantages when applied to a polymeric film due to the increased capacity that that such patterns can provide from the film's increased elongation.

The FIG. 8B chart further shows that the yield curves of the higher amplitude patterns are extremely flat, even in comparison to the 0.15-inch amplitude pattern. For instance, the 0.30-inch pattern has a yield strength of approximately 4.81 pounds at its yield point of approximately 3.8 inches. However, it carries 99% of this load of 4.76 pounds starting at an approximate elongation of 2.65 inches and continues carrying this load or more until it reaches its failure point at 14.28 inches at a failure load of approximately 5.08 pounds.

FIG. 8C illustrates force-to stretch curves for test samples having the same composition, overall dimensions, emboss pattern, and amplitudes as the FIGS. 8A and 8B charts. The FIG. 8C chart, however, illustrates results for stretching in the machine direction (MD) rather than the cross direction. Because of the above-discussed two directional stretching by the sinusoidal emboss patterns, the inventive emboss patterns provide a certain amount of enhanced stretching in the machine direction. For instance, for an elongation of 0.1 inches (2.5% of the sample length) for the 0.60-inch pattern, the force-to-stretch is approximately 1.42 pounds, while the control sample of unembossed film requires approximately 2.34 pounds to stretch the same 0.1 inch. In a typical drawstring trash bag, the machine direction extends along the width of the bag. Utilizing one of the inventive emboss patterns can provide further benefits to the design of such a bag by allowing the bag to expand along its width when filled with debris and thus increasing its holding capacity an additional amount in comparison to a trash bag relying upon the prior art pattern.

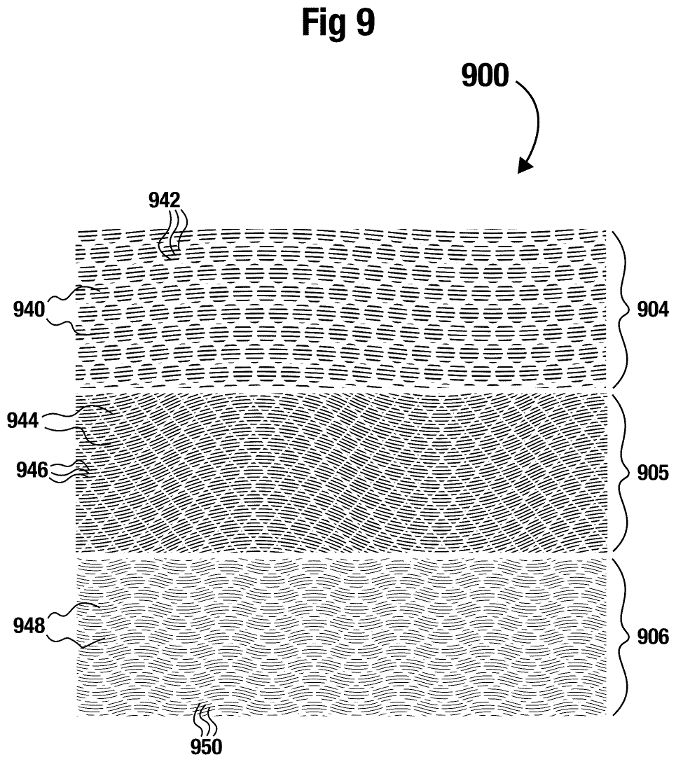

The flexing characteristics of polymeric film can be controlled by varying the waveform of the individual embosses, as discussed above, and by the shape of the embossed regions. FIG. 9 shows emboss pattern 900 with three different embossed sections: upper embossed section 904, middle embossed section 905, and lower embossed section 906. Each of these embossed sections utilizes a different shape for its embossed regions.

FIG. 9 furthers shows upper embossed section 904 with embossed regions 940 having a circular shape. As demonstrated by FIG. 9 in upper section 904, use of same-sized circular shapes as embossed regions 940 results in much less of the overall area of upper section 904 being embossed. With less area embossed and hence not pre-stretched, the overall area of upper section 904 is less efficient in flexing than the middle embossed section 905 with diamond-shaped embossed regions 944 and the lower embossed section 906 with the hexagon-shaped embossed regions 948. Additionally, due to the arcuate shaped unembossed regions of upper embossed section 904, the film is less prone to fold up or hinge when a vertical load is placed on it, further preventing the film from flexing. The sinusoidal embosses 942 of upper embossed section have a relatively low amplitude in comparison to the other embossed sections of emboss pattern 900.

In contrast to upper section 904 of FIG. 9, the embossed regions 944 of middle embossed section 905 have a diamond shape. An emboss pattern utilizing a diamond-shaped embossed regions such as that of section 905 provides the most efficient shape for a flexed emboss pattern; however, such a pattern fails to provide other advantages, such as the resistance of tear propagation of the prior art hexagonal pattern of FIG. 1. The proclivity of middle embossed section 905 to flex is further enhanced by the relatively high amplitude of sinusoidal embosses 946 of the middle embossed section 905 in comparison to the lower amplitude of sinusoidal embosses 942 of embossed regions 940 of the upper embossed section 904. Because of the higher amplitude of sinusoidal embosses 946 and the diamond shape of its embossed regions 944, middle embossed section 905 will elongate much more easily than the other sections. In comparison to middle embossed section 905, upper emboss section 904 will elongate much less to the same applied load.

FIG. 9 further shows lower embossed section 906 with hexagon-shaped embossed regions 948. Sinusoidal embosses 950 of embossed regions 948 have an amplitude between the amplitude of middle embossed section 905 sinusoidal embosses 946 and sinusoidal embosses 942 of upper embossed section 904; hence, the stretch behavior of these lower section sinusoidal embosses 950 will be in between that of the middle section embosses 946 and upper section embosses 942. Regarding the shape of embossed regions 948, hexagonal shaped embossed regions flex more efficiently than circular shaped embossed regions but not as efficiently as diamond shaped embossed regions. With these considerations in mind, under a similar applied load, the flexing behavior of lower embossed section 906 will be between the two other sections.

In at least certain embodiments, upper embossed section 904 sinusoidal embosses 942 can have an amplitude of 0.15 inches, middle embossed section 905 sinusoidal embosses can have an amplitude of 0.60 inches and lower embossed section 906 sinusoidal embosses can have an amplitude of 0.30 inches.

Emboss pattern 900 provides certain advantages over prior art flex patterns, such as embossed pattern 100 of FIG. 1, especially when applied to articles such as the panels of a drawstring trash bag. For example, the relatively inefficient and complex flex pattern of upper embossed section 904 can provide a limited amount of flexing to expand around the bag's contents while providing an increased perception of strength and controlling the growth in the top area of the bag, especially when the bag is removed from a tight-fitting container. This pattern also provides for increased tensile strength in comparison to the other two sections. Middle embossed section 905 provides for a substantial amount of flex to allow the bag's capacity to grow and to conform to bulky objects. Lower embossed section 906 provides a reasonable amount of flex and provides improved resistance to tear propagation, due to the hexagonal shape. Many of these above-discussed advantages hold true as well when only two of these embossed sections are utilized in a flex embossed pattern.

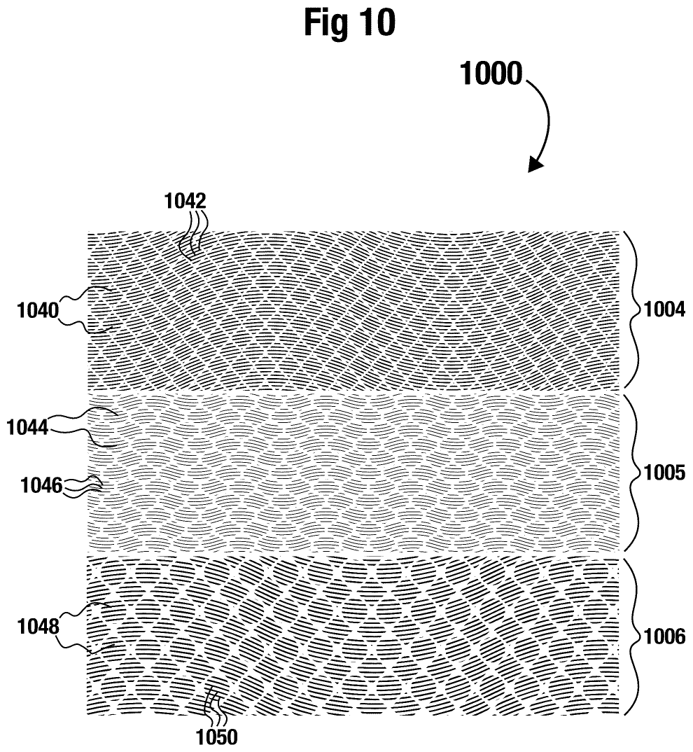

FIG. 10 illustrates an additional emboss pattern 1000. Emboss pattern 1000 includes upper embossed section 1004, middle embossed section 1005, and lower embossed section 1006. FIG. 10 further shows embossed regions 1042 of upper embossed section 1004 having a diamond shape and sinusoidal embosses 1040 having the lowest amplitude of the various embossed regions of embossed pattern 1000. In at least certain embodiments, the amplitude of sinusoidal embosses 1040 can have an amplitude of 0.15 inches.

Also shown by FIG. 10 is lower embossed section 1006 of emboss pattern 1000. Embossed section 1006 comprises embossed regions having two different shapes: circular embossed regions 1048 and diamond-shaped embossed regions 1052. Both of these types of embossed regions 1048 and 1052 comprise sinusoidal embosses 1050. Due to the mixture of shapes and their inability to mesh compactly with each other, lower embossed section 1006 comprises a considerable amount of unembossed film such that its efficiency in flexing is quite low; furthermore, due to the incongruity of these two shapes, its flex behavior is quite complex. FIG. 10 further shows that the amplitude of the sinusoidal embosses 1050 is higher than the amplitude of the sinusoidal embosses 1042 of the upper embossed section 1004. In at least certain embodiments, sinusoidal embosses 1042 can have an amplitude of 0.60 inches.

FIG. 10 further shows middle embossed section 1005 with hexagon-shaped embossed regions 1044. The sinusoidal embosses 1046 of embossed regions 1044 have an amplitude between the amplitude of upper embossed section 1004 sinusoidal embosses 1042 and sinusoidal embosses 1050 of lower embossed section 1006. Regarding the shape of embossed regions 1048, a hexagonal shape flexes more efficiently than the circular and diamond-shaped pattern of section 1006 but not as efficiently as the diamond shaped flex pattern of section 1004. In at least certain embodiments, sinusoidal embosses 1046 can have an amplitude of 0.30 inches.

Flex pattern 1000 of FIG. 10 can be particular advantageous. For instance, when applied to the panels of a drawstring trash bag, the three embossed sections provide performance enhancements to the bag. In particular, upper embossed section 1004 provides a relatively high amount of flex to allow a user to more easily place the bag into a container and allow the bag to expand so that it can receive a greater volume of contents. Middle embossed section 1005 provides a moderate amount of expansion to allow a further increase in volume to the bag while imparting an impression of strength to the consumer by limiting the amount of flex in comparison to upper section 1004. Lower embossed section 1006 provides a limited amount of flex to add a certain amount of capacity to the bag while providing increased perception of strength in comparison to the other two embossed sections. Additionally, due to the incongruities in its flex pattern, section 1006 provides a greater resistance to tears propagating in the film. If only two of these embossed sections are utilized in the construction of a bag, such as upper section 1004 and lower section 1006, many of these advantages remain.

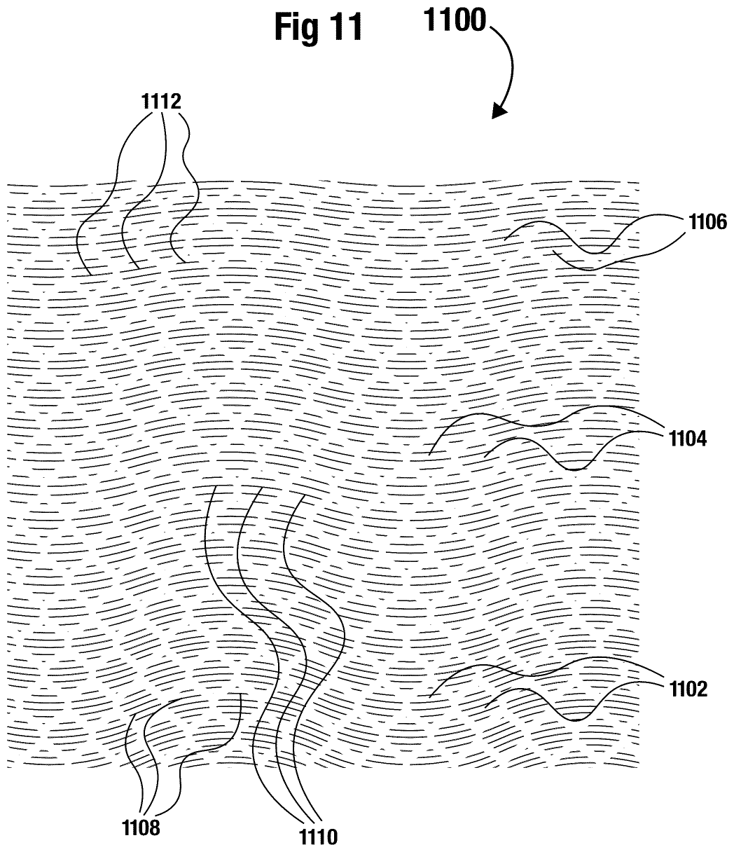

Now turning to FIG. 11, a seventh embodiment of the present invention is shown. Unlike previously discussed embodiments, the amplitudes of the various sets of sinusoidal embosses continuously vary throughout the height of emboss pattern 1100. For instance, reference number 1108 identifies sinusoidal embosses sharing a first amplitude (a first common amplitude emboss set), reference number 1110 identifies sinusoidal embosses sharing a second amplitude (a second common amplitude emboss set), and reference number 1112 identifies sinusoidal embosses sharing a third amplitude (a third common amplitude emboss set).

As illustrated by FIG. 11, the amplitudes of these emboss sets decrease in magnitude from the first amplitude to the third amplitude as the height of their locations increase. Further illustrated is that the various embosses that share the same amplitude follow the same waveform. In between these three identified common amplitude emboss sets 1108, 1110, and 1112, the amplitudes of sinusoidal embosses continually change based upon the vertical location of the embosses. For example, an adjacent emboss above one of the embosses of the first common amplitude emboss set 1108 has a sinusoidal amplitude slightly lower than the amplitude of the embosses of emboss set 1108 and an adjacent emboss below one of the embosses of emboss set 1108 has an amplitude slightly higher than the amplitude of the embosses of emboss set 1108.

FIG. 11 further illustrates first, second, and third comparable amplitude embossed region sets 1102, 1104, and 1106. Due to the sets of sinusoidal embosses of comparable amplitude embossed region set 1102 following similar sinusoidal waveforms, the amplitudes of the sets of sinusoidal embosses of the first comparable amplitude embossed region set 1102 are similar to each other. However, due to a certain amount of offset between adjacent embossed regions of set 1102 and the sinewaves that the sinusoidal embosses of the embossed regions follow, the amplitudes of the embosses are not exactly the same. This relationship described for embossed region set 1102 and its two embossed regions can also be said for emboss region sets 1104 and 1106 and the embossed regions of these sets 1104 and 1106.

The behavior of emboss pattern 1100 illustrated by FIG. 11 can be particularly advantageous. For instance, when applied to the panels of a drawstring trash bag, the above-described variance in amplitude of the sinusoidal embosses can provide for fine-tuning the flex behavior of the bag based upon how the various amplitudes behave as discussed in regards to FIGS. 8A-8C. For instance, the higher area of the bag will have a relatively low amount of flex but carry a higher load than lower areas. In contrast to this, the lower areas will expand more but not carry as much load; nonetheless, due to the lower areas very flat yield curve, the material will continue to expand to increase the bag's volume while still carrying a reasonably high load.

As previously noted, the specific embodiments depicted herein are not intended to limit the scope of the present invention. Indeed, it is contemplated that any number of different embodiments may be utilized without diverging from the spirit of the invention. Therefore, the appended claims are intended to more fully encompass the full scope of the present invention.

We claim:

1. A thermoplastic film, the thermoplastic film having machine and cross directions, the thermoplastic film comprising:
a plurality of embossed regions embossed into the thermoplastic film, the plurality of embossed regions separated by a continuous, unembossed arrangement,
each of the plurality of embossed regions comprising a set of sinusoidal embosses, wherein adjacent embosses of the set of sinusoidal embosses are shaped and spaced from each other to avoid intersection with each other,
the plurality of embossed regions comprising a first embossed region, the first embossed region comprising a first set of sinusoidal embosses,
a sinusoidal emboss of the first set of sinusoidal embosses including opposing first and second end sections and a central section,
the first, second and central sections of the first sinusoidal emboss extending along a length of the sinusoidal emboss, and
machine and cross direction orientations of each of the first, second, and central sections of the first sinusoidal emboss differing from each other.

2. The thermoplastic film of claim 1, further comprising:
the adjacent embosses evenly spaced from each other.

3. The thermoplastic film of claim 1, further comprising:
the adjacent embosses varying in distance from each other.

4. The thermoplastic film of claim 1, further comprising:
each embossed region defined by a boundary with the continuous, unembossed arrangement, the boundary defined by endpoints of the set of sinusoidal embosses and top and bottom sinusoidal embosses of the embossed region.

5. The thermoplastic film of claim 4, further comprising:
the plurality of embossed regions comprising a lower embossed region and an upper embossed region,
the upper embossed region above the lower embossed region,
each emboss of the set of sinusoids of the lower embossed region having a lower region amplitude and each emboss of the set of sinusoids of the upper embossed region having an upper region amplitude, and
the lower embossed region amplitude different from the upper embossed region amplitude.

6. The thermoplastic film of claim 5 wherein:
the thermoplastic film is incorporated into a drawstring trash bag.

7. The thermoplastic film of claim 5, further comprising:
the first set of sinusoidal embosses comprising an upper emboss, a middle emboss, and a lower emboss,
the upper emboss above the lower emboss and the middle emboss between the upper and lower embosses,
the upper emboss having an upper emboss amplitude, the middle emboss having a middle emboss amplitude, and the lower emboss having a lower emboss amplitude, and
the upper emboss amplitude, the middle emboss amplitude, and the lower emboss amplitude each different from each other.

8. The thermoplastic film of claim 5, further comprising:
the upper emboss amplitude greater than the lower emboss amplitude, and
the middle emboss amplitude in between the upper emboss amplitude and the lower emboss amplitude.

9. An emboss pattern embossed onto a web of thermoplastic film, the thermoplastic film having machine and cross directions, the emboss pattern comprising:
an upper embossed section, the upper embossed section having top and bottom emboss boundaries, the top and bottom emboss boundaries extending generally in the machine direction, the upper embossed section extending in the cross direction between the top and bottom emboss boundaries,
a lower embossed section below the upper embossed section, the lower embossed section having top and bottom emboss boundaries extending generally in the machine direction, the lower embossed section extending in the cross direction between the top and bottom emboss boundaries,
at least one of the top and bottom emboss boundaries of the upper and lower embossed sections following a sinusoidal path,
the upper and lower embossed sections comprising a plurality of embossed regions of embosses, each embossed region separated from adjacent embossed regions by an unembossed arrangement,
an upper unembossed section above the top boundary of the upper embossed section,
a middle unembossed section extending from the bottom boundary of the upper embossed section to the top boundary of the lower embossed section,
a lower unembossed section below the bottom emboss boundary of the lower embossed section, and
the upper, middle, and lower unembossed sections having generally flat surfaces devoid of embosses.

10. The emboss pattern of claim 9, further comprising:
each embossed region of the plurality of embossed regions comprising a set of sinusoidal embosses, wherein each sinusoidal emboss of the set of sinusoidal embosses are spaced from each other such that they do not intersect each other.

11. The emboss pattern of claim 10, further comprising:
each embossed region defined by a boundary with the continuous, unembossed arrangement, the boundary defined by endpoints of the sinusoidal embosses of the set of sinusoidal embosses and top and bottom sinusoid embosses of the embossed region.

12. The emboss pattern of claim 11, further comprising:
the thermoplastic film of each sinusoidal emboss stretched in both the machine and cross directions by formation of the sinusoidal emboss, a magnitude of stretching for both the machine and cross directions continuously varying along a length of each sinusoidal emboss.

13. The emboss pattern of claim 12, further comprising:
a sinusoidal emboss of the set of sinusoidal embosses including opposing first and second end sections and a central section,
the first, second, and central sections of the sinusoidal emboss extending along a length of the sinusoidal emboss, and
the machine and cross direction orientations of each of the first, second, and central sections of the sinusoidal emboss differing from each other.

14. The emboss pattern of claim 13, further comprising:
the top and bottom boundaries of the upper and lower embossed sections following one or more sinusoidal paths.

15. The emboss pattern of claim 14, further comprising:
the top and bottom boundaries of the upper section following an upper sinusoidal path,
the top and bottom boundaries of the lower section following a lower sinusoidal path, and
the upper sinusoidal path different from the lower sinusoidal path.

16. The thermoplastic film of claim 15, further comprising:
the upper sinusoidal path having a different wavelength and amplitude from the lower sinusoidal path.

17. The emboss pattern of claim 14, further comprising:
the one or more sinusoidal paths having the same amplitude and wavelength.

18. The emboss pattern of claim 15 wherein:
the thermoplastic film is incorporated into a drawstring trash bag.

19. An emboss pattern embossed onto a web of thermoplastic film, the thermoplastic film having machine and cross directions, the emboss pattern comprising:
a first embossed section, the first embossed section having top and bottom emboss boundaries, the top and bottom emboss boundaries extending generally in the machine direction, the first embossed section extending in the cross direction between the top and bottom emboss boundaries,
a second embossed section separate from the first embossed section, the second embossed section having top and bottom emboss boundaries extending generally in the machine direction, the second embossed section extending in the cross direction between the top and bottom emboss boundaries,
the first and second embossed sections each comprising a plurality of embossed regions of embosses, each embossed region separated from adjacent embossed regions by an unembossed arrangement,
each embossed region of the first embossed section comprising a set of sinusoidal embosses, a wavelength of the sinusoidal embosses extending generally in the machine direction,
each of the embossed regions of the second embossed section comprising a set of embosses extending generally in the machine direction, and
each of the plurality of embossed regions of the first embossed section having one or more first embossed region shapes and each of the plurality of embossed regions of the second embossed section having one or more second embossed region shapes, the one or more first embossed region shapes different from the one or more second embossed region shapes.

20. The emboss pattern of claim 19, further comprising:
each emboss of the set of sinusoidal embosses of the one of the plurality of embossed regions of the first embossed section having a first amplitude,
one of the plurality of embossed regions of the second embossed section comprising a set of sinusoidal embosses, each emboss of the set of sinusoidal embosses having a second amplitude, and
the first amplitude different from the second amplitude.

21. The emboss pattern of claim 20, further comprising:
a third embossed section separate from the first and second embossed sections, the third embossed section having top and bottom emboss boundaries extending generally in the machine direction, the third embossed section extending in the cross direction between the top and bottom emboss boundaries, and
the third embossed section comprising a plurality of embossed regions of embosses, each embossed region separated from adjacent embossed regions by an unembossed arrangement.

22. The emboss pattern of claim 21, further comprising:
each embossed region of the third embossed section comprising a set of sinusoidal embosses, a wavelength of each emboss of the sinusoidal embosses extending generally in the machine direction.

23. The emboss pattern of claim 22, further comprising:
each emboss of one set of sinusoidal embosses of one of the plurality of embossed regions of the first embossed section having a first amplitude,
one of the plurality of embossed regions of the second embossed section comprising a set of sinusoidal embosses, each emboss of the set of sinusoidal embosses having a second amplitude,
each emboss of one set of sinusoidal embosses of the plurality of embossed regions of the third embossed section having a third amplitude, and
the first, second and third amplitudes different from each other.

24. The emboss pattern of claim 23, further comprising:
the first amplitude less than the second amplitude and the second amplitude less than the third amplitude.

25. An emboss pattern embossed onto a web of thermoplastic film, the thermoplastic film having machine and cross directions, the emboss pattern comprising:
a plurality of embossed regions embossed into the thermoplastic film, the plurality of embossed regions separated by a continuous, unembossed arrangement, the plurality of embossed regions comprising at least an upper embossed region and a lower embossed region, each of the plurality of embossed regions comprising a set of sinusoidal embosses, wherein adjacent embosses of the set of sinusoidal embosses are shaped and spaced from each other to avoid intersection with each other,
the set of sinusoidal embosses of the upper embossed region comprising at least first and second sinusoidal embosses, the first sinusoidal emboss comprising a first amplitude and the second sinusoidal emboss comprising a second amplitude,
the set of sinusoidal embosses of the lower embossed region comprising at least third and fourth sinusoidal embosses, the third sinusoidal emboss comprising a third amplitude and the fourth sinusoidal emboss comprising a fourth amplitude, and
the first amplitude different from the second amplitude.

26. The emboss pattern of claim 25, further comprising:
the third amplitude different from the second amplitude.

27. The emboss pattern of claim 26, further comprising:
the fourth amplitude different from third amplitude.

28. The emboss pattern of claim 27, further comprising:
the first, second, third, and fourth amplitudes each different from each other.
